(19) United States
(12) Patent Application Publication
(10) Pub. No.: US 2013/0021479 A1
(43) Pub. Date: Jan. 24, 2013

(54) VIDEO-BASED TRANSMISSION OF ITEMS

(71) Applicants: David J. McLaughlin, Arlington, MA (US); James Joyce, Dublin (IE)

(72) Inventors: David J. McLaughlin, Arlington, MA (US); James Joyce, Dublin (IE)

(21) Appl. No.: 13/555,760

(22) Filed: Jul. 23, 2012

Related U.S. Application Data
(60) Provisional application No. 61/510,767, filed on Jul. 22, 2011.

(51) Int. Cl. H04N 5/225; G06F 15/16

(52) U.S. Cl. 348/207.1; 709/218; 348/E05.024

(57) ABSTRACT

A method includes, in a server residing in a network of interconnected computers, uploading a video from a user device in the network, attaching an item to the uploaded video, and sending a link to the uploaded video with attached item to a recipient.

### CROSS-REFERENCE TO RELATED APPLICATIONS

This application claims the benefit of priority of U.S. Provisional Application Ser. No. 61/510,767, filed on Jul. 22, 2011, the disclosure of which is incorporated herein by reference in its entirety.

### BACKGROUND OF THE INVENTION

The present invention relates to video-based transmission of items.

In general, traditional electronic communication media includes email, text messaging, social networking, and so forth. In many of these traditional electronic communication media, text drives the application. And as with any text-based electronic communication, a message in written words is sometimes misinterpreted or lost in translation, failing to convey the actual intention of an originator to one or more recipients. Furthermore, text-based communication has a tendency to feel impersonal.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for video-based transmission of items.

In one aspect, the invention features a method including, in a server residing in a network of interconnected computers, uploading a video from a user device in the network, attaching an item to the uploaded video, and sending a link to the uploaded video with attached item to a recipient.

In another aspect, the invention features a method including, in a server residing in a network of interconnected computers, receiving user information from a user device linked to the network, sending a camera activation signal to the user device, activating a user device camera and enabling a user to record a video, uploading an attachment from the user device, associating the attachment with the recorded video, and storing the recorded video along with a title and text description of the video and association attachment.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram.

FIG. 2 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

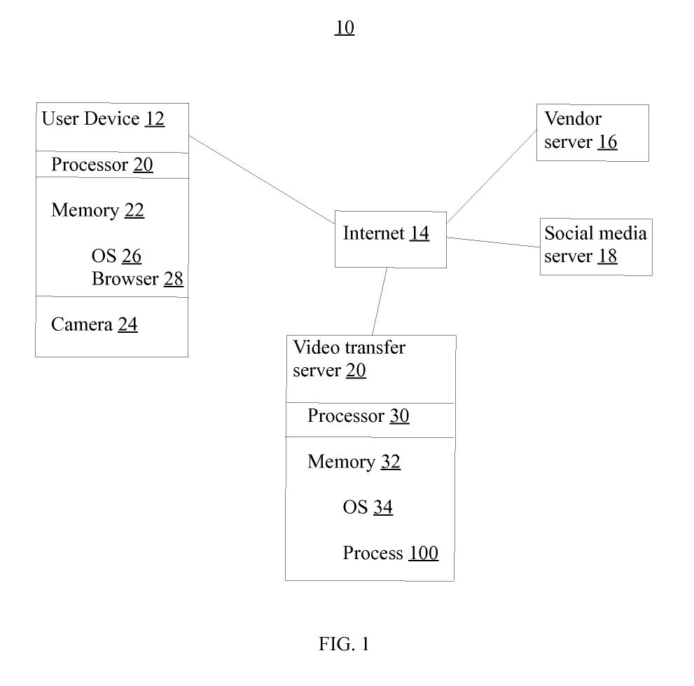

As shown in FIG. 1, an exemplary system 10 includes a user device 12 linked to a network of interconnected computers, e.g., the Internet, 14. Linked to the Internet 14 are one or more vendor servers 16, one or more social media servers 18 and a video transfer server 20. The one or more vendor servers 16 host web sites for commercial products and/or services. The one or more social media servers 18 host social networking applications, such as Twitter®, LinkedIn®, Facebook®, and so forth.

The user device 12 includes a processor 20, a memory 22 and a camera 24. The memory 22 includes an operating system (OS) 26, such as Windows®, Linux®, iOS® or Android®, and a browser process 28. The camera 24 enables recording of a video snapshot and/or short video clip. Example user devices include personal computers, laptop computers, notebook computers, tablets, personal data assistants (PDAs), smart phones, and so forth. In one embodiment, a user device 12 that is a smart phone includes an app that communicates with the video transfer server 20 rather than a browser process.

The video transfer server 20 includes a processor 30 and a memory 32. The memory 32 includes an OS 34, such as Windows®, Linux®, or Unix®, and a video-based transmission of items process 100. Process 100, fully described below, enables using video, either synchronous or asynchronous, as a primary vehicle to transmit items that have value to a sender and/or recipient(s). An item can be a virtual good, such as a music or movie file, an electronic gift card, a physical good, in which case the attached gift is only a representation of the physical good, or an item that does not have defined monetary or commercial value but is desirable or are believed to be desirable between two parties, i.e., a sender and a recipient. Such non-monetary items can include images or photographs, either proprietary or non-proprietary, documents containing business intelligence or information, links to actionable web pages such as party RSVP actions, files that are products or versions of a product in development, and so forth.

Process 100 can include delivering redemption codes designed to be redeemed for non-digital items as well as purely digital items. Non-digital items can include real gifts, such as a baseball cap of their favorite professional team. Process 100 delivers a video that has a representation of the item attached with the actual gift to show up via email, United Parcel Service, and so forth.

As used herein, the video is not an add-on to an item. Rather, process 100 provides an interface to enable a user/recipient to choose, send, and receive the item. In other words, the item is added on, or attached, to the video.

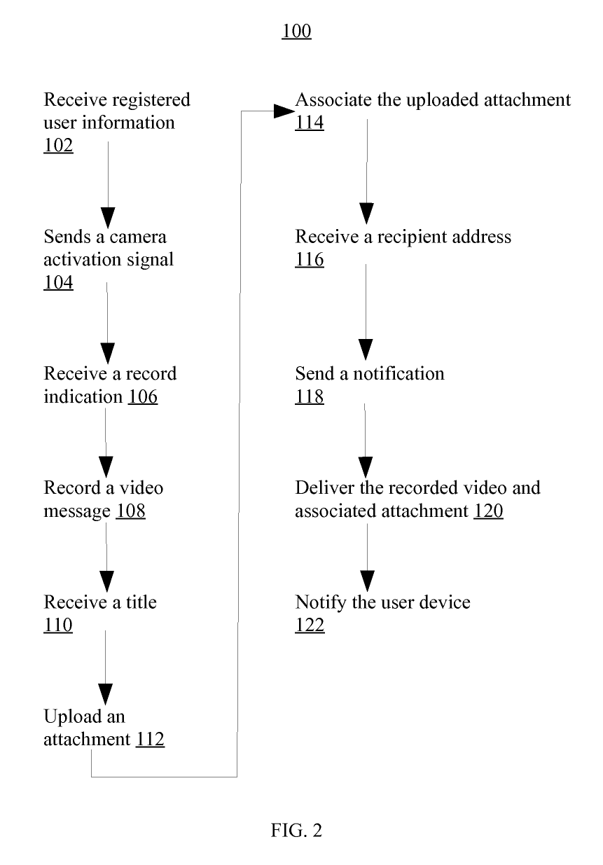

As shown in FIG. 2, process 100 includes receiving (102) registered user information from a user device. The user information can be a username and password.

Process 100 sends (104) a camera activation signal to the user device, activating a user device camera and enabling a user to record a video message.

Process 100 receives (106) a record indication from the user device that engages the user device camera and records (108) a video message for a specified period of time, such as 0-60 seconds.

Process 100 receives (110) a title and optional brief text description from the user device when the recording is complete.

Process 100 uploads (112) an attachment from the user device and associates (114) the uploaded attachment with the recorded video. In general, three types of items may be attached, i.e., a commercial mechanism, a link, or a file. Commercial mechanisms can include unique redemption codes, merchant vouchers, vendor service vouchers, and so forth. Links enable a recipient to access information or opportunities that offer value to him or her, including for example, a page where he or she can register to accept an invitation to attend an event, or web destinations where recipients can consumer information that has value for them or for their businesses. File can include all types, such as business information documents, photographs or other image files, or other applications that offer value for the recipient.

To enable the attachment, process 100 is in communication with various databases and web-hosted file storage destinations, such as Dropbox®, and is able to access a local storage device on the user device, such as hard drive of the computer the user is on or a USB drive or other local storage device, as well as web-hosted file storage destinations. In embodiments, the attachment originates from a linked database or directory.

Process 100 receives (116) a recipient address from the user device and sends (118) a notification to the recipient address that the recorded video and associated attachment are available for consumption by clicking on a link, such as a universal resource locator (URL), in the notification. The notification may be sent to the recipient address using email, Short Message Service (SMS), public or private message bulletin board, or social networking site, such as Twitter®, LinkedIn® , Facebook®, and so forth.

Process 100 delivers (120) the recorded video and associated attachment when it receives notification from the recipient address.

Process 100 notifies (122) the user device that the recorded video and associated attachment have been consumed by a user at the recipient address.

Process 100 is not a platform for attaching a video to an electronic gift. Process 100 enables an attachment of an item to a video. The item may be an item that was purchased or provided; the cost of the gift to the sender is not relevant. What is relevant is whether the item has presumed value, either monetary or non-monetary, for the recipient(s).

For example, one may use process 100 to transmit coupons or promotional items provided at no cost, in addition to other items. Process 100 applies whether the item is being distributed for personal or commercial reasons or for reasons related to promotional marketing, or for reasons related to more general business productivity, advancement and growth, including both the acquisition and retention of customers and revenues.

Process 100 enables a user with a computer, smartphone, tablet or wireless capable personal data assistant (PDA) to record a video and then select an item from a stored or linked inventory of items of value to deliver in conjunction with the video to a recipient or group of recipients. More specifically, the item is delivered in conjunction with the video, i.e., a link to a specific place on a server where both video and item can be accessed. A recipient receives the link, which causes the recipient to come to the server to consume the video and download and/or act on the attached item of value.

Process 100 adds a new dimension and functionality to video communication, which deepens the meaning and value of that communication practice and of the individual video artifact, and which deepens the value of the practice of electronically transferring items of value between electronically connected individuals or groups. Process 100 personalizes a practice of electronic gifting by enabling senders to attach an item to a composed message in video format. Process 100 introduces a new medium or toolset by which merchants, both online and offline, can sell product, and by which other business people can engage, move and serve their customers, prospects, colleagues, employees and other third-party partners and vendors. The value of this behavior is that video is in many cases a more effective communication format than text-based communication.

Process 100 can include a link to a contacts database, enabling a sender to easily select the recipient(s) from the contact database. Process 100 includes an ability to share or republish a video with attachment or a notification of and link to that video with attachment via email, Multimedia Messaging Service (MMS) and online social networks, such as Facebook®, Twitter® and LinkedIn®, and to blogging services such as Wordpress® and Tumble:), or via SMS or to a bulletin board or any public-facing website via either link or embed code. Process 100 provides an originator with an ability to control whether follow-on sharing of a video with attachment is allowed or not.

Process 100 enables a recipient of a video with attachment to respond with or without attaching an item, simply taking advantage of the rich nuance that video offers as compared to text-based communication.

In the case of commercial items (i.e. gifts of a defined monetary value), process 100 includes an interface for redeeming the gift in such a way that risk of fraud is minimized, such as the use of a unique numeric redemption code, and this redemption mechanism may be employable in-store and/or online as the case may be. When the attached item is an e-giftcard, process 100 includes, or links to, a functionality for tracking a balance remaining on the e-giftcard. When the gift is a physical item to be shipped, process 100 provides the originator with the option to have a time-release feature on the video with attachment. This means that he or she has the choice of having the video with attachment or message reach the recipient's inbox or other electronic delivery destination immediately after it is sent, or at some other point in time, or to coordinate the delivery of the notification message to the recipient's inbox or other electronic delivery destination with the delivery of the physical gift to the shipping address. This operates in conjunction with delivery tracking software of a shipping company.

Process 100 can include a historical function, i.e., an ability for senders and recipients to view and manage recent videos with and without items attached.

In operation, a user on the user device registers with the video transfer server 20. Registration includes profile information such as a username name, password, email address and other information. Registration also includes creating and maintaining a contact list of potential recipients. Registration information is stored on the video transfer server 20 and profile/recipient information can be added, modified and deleted by the registered user.

Each time the user enters their username and password on the video transfer server 20, they are able to view received, sent, and draft video messages, or they can record a new video message. If they choose to record a new video, process 100 prompts the user to begin recording a video that is then stored on the video transfer server 20. Once the video is recorded, the user is afforded an opportunity to review the recorded video and may re-record the video if it does not meet with the satisfaction of the user. Recorded videos are stored on the video transfer server 20 and the video originator may review, resend and delete stored video that they originated.

Once the video is recorded, it must be titled and the user may choose to add a short text description. Also process 100 presents the ability to access linked repositories of files that may add value to the video, as well as a catalog of items from vendors that may be attached to the video and prompts the user to select one or more of the items from the catalog. Process 100 provides strategic alliances with vendors offering items and can offer a plugin to a vendor's website, linking the vendor website to the video transfer server 20. This provides the vendor with a video gifting capability using the video transfer server 20. The catalog of gifts is stored by the video transfer server 20 internally or on a storage device linked to the video transfer server 20. The user may also select to upload a file from their own user device rather than selecting a gift from the list. The user may also select to send the recorded video without an attachment.

In the example of the user selecting a gift, once the gift, i.e., an item or a gift card, is selected, process 100 prompts the user to select one or more recipients (end users) from their personal contacts list stored by the video transfer server 20 or type in a new email address of an intended recipient, which then is stored in the user's contact list as a new entry. Once a recipient is selected, the user is prompted to send a notification of the recorded video along with the selected gift to the designated recipient. Once the send indicator is selected, the recorded video and selected gift are sent via electronic mail to the intended recipient.

When the intended recipient receives the email or other electronic notification from video transfer server 20, it contains a hyperlink to the recorded video and indication of an attached gift that is stored on the video transfer server 20. Process 100 may request authentication from the recipient. Once the recipient is authenticated, the stored video is played and the attached gift is presented in a digital format. The recipient may play, pause, rewind and replay the video, which is stored on the video transfer server 20. If the recipient has more than one received video stored on the video transfer server 20, the recipient may search and/or tag the video he/she has received. An example gift is a $20 gift certificate to a particular restaurant in Boston. The video transfer server 20 presents a unique electronic redemption code so the recipient can consume the attached gift either online or in a bricks and mortar store.

Once video viewing is complete process 100 notifies the originator that it has been delivered, whether is has actually been viewed and whether the attached item has been viewed. And once video viewing is complete process 100 offers the recipient an option to reply to the originating user using text and/or video. The recipient can also share the video with one or more email/text messaging/social networking users. In one implementation, the recipient can download a copy of the received video to their user device and/or export one or more stored received videos to other users.

Payment for the gift may be taken within the application by the company/vendor that provides video gifting capability or on the video transfer server 20. In one example, video gifting may be coupled with a merchant/vendor site in such a way that payment occurs on the merchant site.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back-end component (e.g., a data server), or that includes a middleware component (e.g., an application server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A method comprising:
in a server residing in a network of interconnected computers, uploading a video from a user device in the network;
attaching an item to the uploaded video; and
sending a link to the uploaded video with attached item to a recipient.

2. The method of claim 1 wherein the item is selected from the group consisting of a commercial item, a link, and a file.

3. The method claim 2 wherein the commercial item is selected from the group consisting of a unique redemption code, a merchant voucher, and a vendor service voucher.

4. The method of claim 2 wherein the link enables a recipient to access information or opportunities that offer value.

5. The method of claim 2 where the file is selected from the group consisting of a document, a photograph, an image and a file.

6. The method of claim 1 further comprising sending a notification to the user device when the link is opened.

7. The method of claim 1 wherein the user device is selected from the group consisting of a personal computer, a laptop computer, a notebook computer, a tablet computer, a personal data assistant (PDA), and a smart phone.

8. A method comprising:
in a server residing in a network of interconnected computers, receiving user information from a user device linked to the network.
sending a camera activation signal to the user device, activating a user device camera and enabling a user to record a video;
uploading an attachment from the user device;
associating the attachment with the recorded video;
storing the recorded video along with a title and text description of the video and associated attachment.

9. The method of claim 8 further comprising:
sending a link to the recorded video and associated attachment via electronic delivery to a recipient selected by a user of the user device;
delivering the recorded video and associated attachment to the recipient upon activation of the link.

10. The method of claim 9 further comprising notifying the user device of the delivering.

11. The method of claim 8 wherein the user information comprises a username and password.

12. The method of claim 10 wherein notifying comprises sending an email, sending a Short Message Service (SMS), delivering a message on public or private message bulletin board, or delivering a message to a social networking site.

13. The method of claim 8 wherein the user device is selected from the group consisting of a personal computer, a laptop computer, a notebook computer, a tablet computer, a personal data assistant (PDA), and a smart phone.

14. The method of claim 9 wherein the recipient is listed in a store comprising a plurality of recipients.

15. The method of claim 8 wherein the attachment is selected from the group consisting of a commercial item, a link, and a file.

16. The method claim of 15 wherein the commercial item is selected from the group consisting of a unique redemption code, a merchant voucher, and a vendor service voucher.

17. The method of claim 15 wherein the link enables a recipient to access information or opportunities that offer value.

18. The method of claim 15 where the file is selected from the group consisting of a document, a photograph, an image and a file.

19. The method of claim 8 wherein the video originates from a linked database or directory.
